(19) United States
(12) Patent Application Publication
(10) Pub. No.: US 2003/0053650 A1
(43) Pub. Date: Mar. 20, 2003

(54) Earphone device for motorcycle rider and passenger

(76) Inventor: Kuo-Shou Wang, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/955,989

(22) Filed: Sep. 20, 2001

(51) Int. Cl. H04R 25/00

(52) U.S. Cl. 381/384; 381/376

(57) ABSTRACT

The present invention relates to an earphone device for motorcycle rider and passenger, more particularly to an earphone having a main circuit board with major components such as an interactive mode switch, a mobile phone connector, and a speaker connector, and being coupled to a safety helmet that has a loudspeaker and a microphone on it, or any caps that have similar function and structure as those of a safety helmet; characterized in that by using the connection of separated connection lines of the handset of the mobile phone, and the loudspeaker and microphone of the safety helmet to the main circuit board. If the user rides on the motorcycle as a rider or a passenger and wants to use the mobile phone, the user can talk directly and easily to the caller or the receiver via the microphone and speaker of the phone that is connected to the safety helmet. It assures and enhances the driving safety since the rider does not need to hold the handset for communication. In addition, when the motorcycle has a rider and a passenger, the connector of the main circuit board designated for the interactive communication has installation of mutually connected connection line, so that the rider or passenger can directly proceed with the conversation via the loudspeaker and microphone of the safety helmet without a need to turn his/her head frequently and thus improve the situation of the inconvenience and danger of the traditional way of talking between the rider and the passenger. Hence, it improves the safety of riding a motorcycle in great extent.

### BACKGROUND OF THE INVENTION

1. Field of the Invention

The present invention relates to an earphone device for motorcycle rider and passenger, more particularly to an earphone having a main circuit board with major components such as an interactive mode switch, a mobile phone connector, and a speaker connector being coupled to a safety helmet that has a loudspeaker and a microphone on it, or any caps that have similar function and structure as those of a safety helmet; characterized in that the handset of the mobile phone is connected by separated connecting lines, and the loudspeaker and microphone of the safety helmet is connected to the main circuit board.

2. Description of the Prior Art

In general, most common earphones used for mobile phone are divided into the following types: one of the types is using an earphone line to directly connect to the handset of a mobile phone and the earphone being plugged into the user's ear such that the pedestrian or the driver can talk with others over the mobile phone, while it still keeps the privacy of the conversation as well as maintains a convenient and safe effect. The second type is connecting the earphone line of the mobile phone directly to the stereo equipment of the vehicle such that the driver can talk with others via the mobile phone and does not need to wear an earphone onto his/her ear. The third type is the currently promoted wireless earphone (including microphone), which basically lets the user to wear such wireless earphone onto the user's ear, and does not require to carry the handset of the mobile phone nearby, but just keep it in a certain predetermined distance for receiving the wireless frequency in order to enhance the convenience of its application.

Undeniably, the foregoing earphones actually have the practical enhancement in convenience and safety for the application of mobile phone communications for pedestrians and drivers. However, we all know that when it is operated for the pedestrians and drivers, the problem of communication without wearing a wireless earphone or via the stereo is inconvenient. If it is used for the rider or passenger of a motorcycle, there is no stereo equipment, and therefore it is not applicable for such situation. For the application by wearing an earphone, the airflow or the safety helmet will affect the application and cause inconvenience; for example, when the motorcycle rider or passenger wears a half-hood helmet, the earphone plugged or worn onto the ear, it constitutes an obstacle for wearing the helmet, and causes the insecurity or instability or even falling off of the helmet due to the airflow while riding on the motorcycle. If the safety helmet is a full-hooded one, then the earphone regardless of cabled or wireless will cause uneasiness directly to the ear when wearing a safety helmet. In some cases, the user may not be able to wear the helmet at all. The most common ways that motorcycles use the mobile phone are either stopping the motorcycle for the call, or holding the handset by one hand while controlling the motorcycle by the other. The latter does not just violate the laws, but also directly affects the rider's safety.

In view of the shortcomings of the prior art mentioned above, the traditional way of using the mobile phone while riding on a motorcycle is improper, and should be improved. Particularly, holding a handset while riding on a motorcycle should be prohibited and improved immediately. Thus the inventor of the present invention based on years of experience accumulated from the engagement in the related industry conducted extensive research to resolve the foregoing shortcomings and invented the present invention.

Therefore, the primary objective of the present invention is to provide an earphone for the motorcycle rider and passenger, wherein by means of a built-in or a hanging microphone and loudspeaker on the safety helmet or helmet of similar function for the telephone conversation. The earphone and loudspeaker can be connected to a main circuit board (main system) by a connecting wire, and such main circuit board has an interactive switch and a connector designed for interactive conversation. The main circuit board on the end of motorcycle rider can be connected to the connector designated for interactive conversation by a connecting wire. Naturally, by means of the control of the interactive conversation switch, the motorcycle rider and passenger can simply talk over the mobile phone with clear tones in a very easy and convenient manner without a need of turning one's head frequently for the talk, and thus improves the safety in a great extent.

The other objective of the present invention is to provide an earphone for the motorcycle rider and passenger, wherein by means of having another connector of the mobile phone connected to the main circuit board (main system), the motorcycle rider's mobile phone can be connected to the connector of the main circuit board by a connecting wire, and with the loudspeaker and microphone being disposed onto the safety helmet, the motorcycle rider or passenger can talk over the mobile phone with clear tones, and most importantly the users no longer has to hold the handset by one hand and rides the motorcycle with the other. It thus enhances the safety of riding a motorcycle.

A further objective of the present invention is to provide an earphone for the motorcycle rider and passenger, wherein by means of the loudspeaker and microphone being built in or hung directly onto the safety helmet, the motorcycle rider and passenger will not have any inconvenience of wearing the safety helmet at all, and it definitely accomplishes the desired practical effect.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a planar schematic diagram showing an embodiment of the present invention

FIG. 2 is a block diagram of the main circuit board of the present invention.

### DETAILED DESCRIPTION OF THE PREFERRED EMBODIMENT

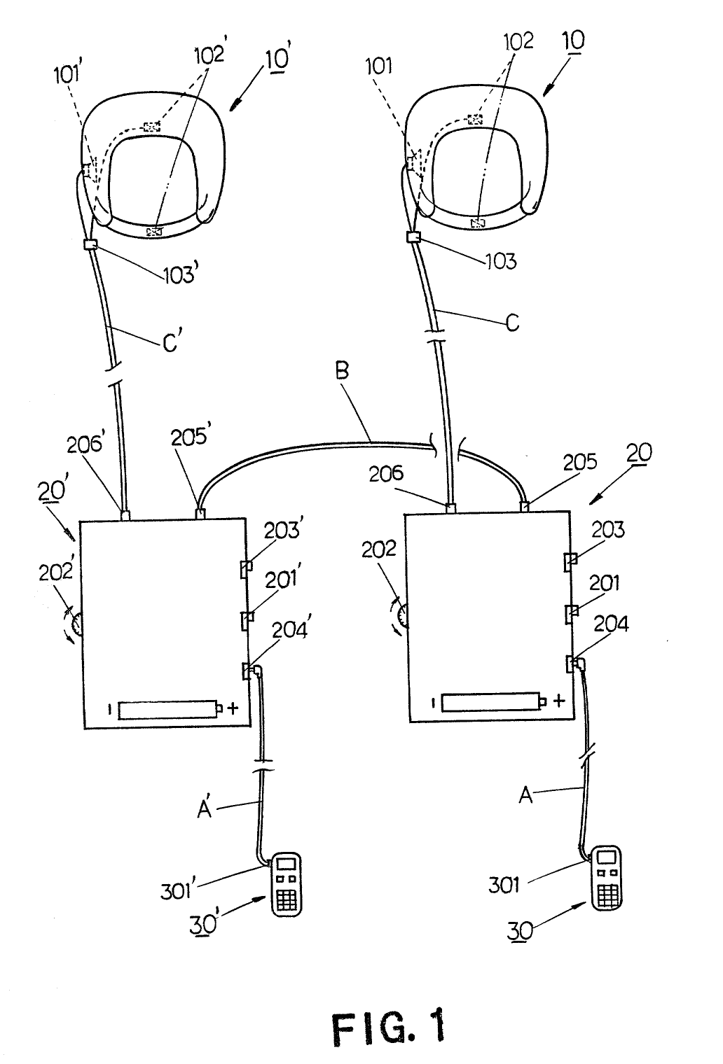

Please refer to FIG. 1, which clearly shows an earphone device for the motorcycle rider and passenger according to the present invention, mainly comprising a safety helmet 10 or cap 10′ of similar function having a loudspeaker and a microphone, and two main circuit boards 20, 20′ (main system).

The safety helmet 10 (10′) has a loudspeaker 101 (101′) and a microphone 102 (102′) which can be build-in or installed externally according to the predetermined model of the safety helmet, so that they can be disposed near to the human ear and mouth respectively. The connection wires can be connected to an activity connector 103 (103′) which can be built in or hung externally onto an appropriate position of the safety helmet 10 (10′).

The main circuit board (main system) 20 (20′) mainly comprises an electric power switch 201 (201′), a volume button 202 (202′), an interactive mode switch 203 (203′), a mobile phone connector 204 (204′), a conversation designated connector 205 (205′), and a conversation connector 206 (206′); wherein the mobile phone connector 204 (204′) can be connected to the earphone connector 301 (301′) of the handset 30 (30′) via the connecting line A (A′); the two conversation designated connector 205 (205′) can be connected via the connecting line B; the conversation connector 206 (206′) can be connected to the activity connector 103 (103′) of the safety helmet 10 (10′) via the connecting line C (C′) so that the loudspeaker 101 (101′) and the microphone 102 (102′) of the two safety helmets 10 (10′) can be directly connected to the handset 30 (30′) of the mobile phone, and the loudspeaker 101 (101′) and the microphone 102 (102′) of the two safety helmets 10 (10′) can be directly connected to each other, and it also can be controlled by the two interactive mode switches 203 (203′).

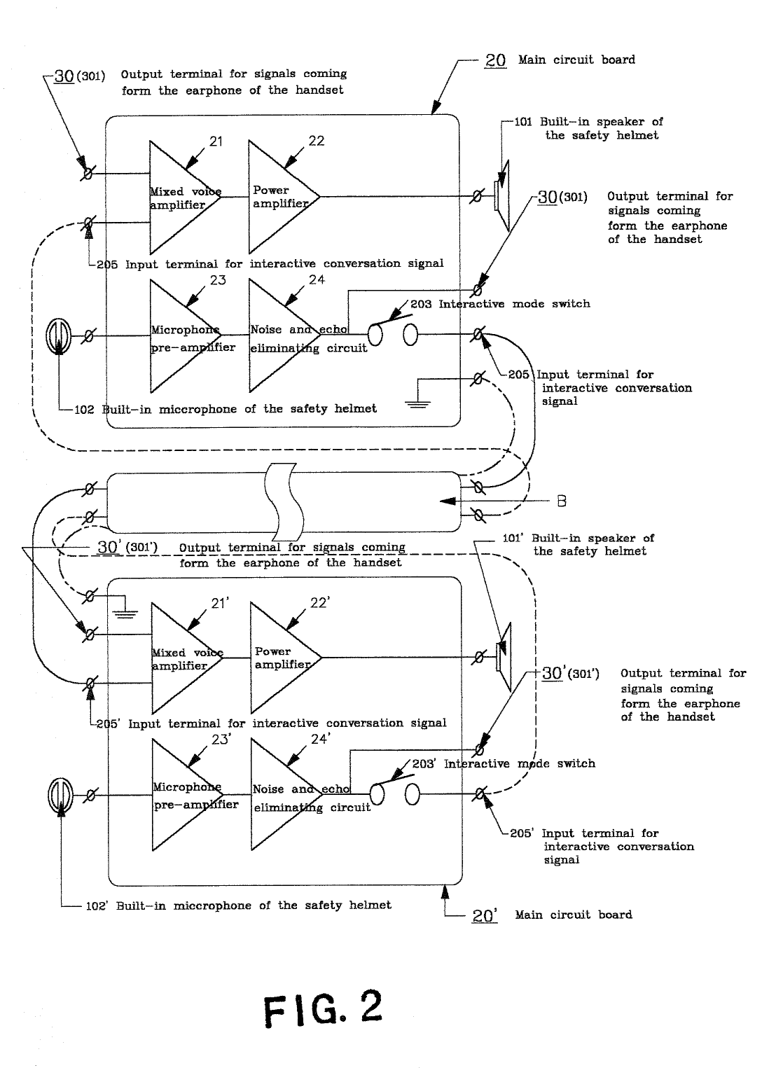

Furthermore, please refer to FIG. 2, which shows the principle of actions of the two main circuit boards 20 (20′) mainly comprising a mixed audio amplifier 21 (21′) that is used to mix the audio signal from the handset 30 (30′) of the mobile phone and the microphone 102 (102′) of another safety helmet 10′ (10); another power amplifier 22 (22′) for strengthening the signal of the mixed amplifier to push the loudspeaker 101 (101′) of the safety helmet 10 (10′) and further enables the wearer of the safety helmet 10 (10′) can hear the voice from the handset 30 (30′) clearly or the sound of the mutual conversation; a microphone pre-amplifier 23 (23′) which are disposed in pairs to amplify the feeble sound from the microphone 102 (102′) of the safety helmet 10 (10′); a noise and echo eliminating circuit 24 (24′) for eliminating the high frequency noise received from the microphone 102 (102′) and suppress the occurrence of the echo.

By means of the assembly of the above components according to the present invention, a motorcycle rider or passenger just needs to turn on the handset directly for the listening while they are riding the motorcycle, and the voice coming from the caller will enter into the mixed audio amplifier 21 of the main circuit board 20 via the earphone connector 301, connecting line A, and the mobile phone connector 204, and then the signal after being amplified will be sent to the power amplifier 22 again in order to push the loudspeaker 101 of the safety helmet 10. The volume button 202 is used to control the volume so that the wearer of the safety helmet 10 can hear the caller's noise clearly. Further, the noise from the receiver's helmet 10 (either from the motorcycle rider or passenger) will be sent to the microphone pre-amplifier 23 via the microphone 102 that is disposed on the safety helmet 10. Since the audio signal is of a very weak voltage, the noise will come together with the signal when it is amplified, therefore the signal is sent to the noise and echo eliminating circuit for noise elimination, and in the meantime, it also suppresses the occurrence of echoes. The audio signal after processed will be sent to the handset 30 via the earphone connector 301 of the handset 30 and then from the handset 30 to the call receiver, so that it accomplishes the effect of direct calls. By the implementation and operation of the present invention, the motorcycle rider and passenger can make call and listen to a call through the loudspeaker 101 and the microphone 102 of the safety helmet 10 while riding the motorcycle if they want to make a call through mobile phone. It does not require the user to hold the handset by one hand while controlling the motorcycle by the other hand. It does not make the call much easier and more convenient, but it also provides a better quality effect for the clear tones, and more particularly it drastically enhances the safety of riding a motorcycle more directly and definitely.

From the description above, we know that when the motorcycle is loaded with the rider and the passenger, the present invention has the implementations of two safety helmet 10, 10′ and tow main circuit boards 20, 20′, and the handsets 30, 30′ are identical, therefore the foregoing call can be implemented in a simpler, more convenient, and safer manner with better quality of speaking tone effect. It has the same effect for either the motorcycle rider or the passenger.

Furthermore, when the motorcycle is loaded with rider and passenger and they want to communicate with each other, the present invention has the implementation of a connecting line B to connect the interactive conversation designated connector 205, 205′ of the two main circuit boards 20, 20′, the two persons just need to turn on the interactive mode switch 203, 203′ directly. Naturally, the voices from both parties can be transmitted via the connecting line B, and it also accomplishes the same clear tone effect as described above, and the mutual communication and talk between the rider and the passenger. It definitely can be done in an easy, natural, simple, and convenient manner. More particularly, it can directly improve the shortcomings of the traditional way that requires the rider to turn his/her head frequently to talk to the passenger, and thus it enhances the safety of riding a motorcycle in a great extent.

From the above description, since each of the two main circuit boards 20, 20′ has an interactive mode switch 203, 203′, therefore when any one of the parties is using the mobile phone while riding the motorcycle, and does not want the other party to listen to the phone call, the user of the mobile phone can turn off the interactive mode switch 203, 203′. Of course, the present invention can be implemented as a phone for three-way communication or a multiple-user circuit on the main circuit board 20, 20′ so that the motorcycle rider or passenger can operate the mobile phone for a three-way or a multiple-speaker conversation. However, such multiple speakers system is a prior art and not intended to be covered in the present invention, and thus not described here.

Furthermore, the power used by the two main circuits 20, 20′ could be DC battery, and by means of the control of the power switch 201, 201′ and the constant voltage circuit, the power can be disconnected when the earphone according to the present invention is not in use, and also keeps a constant power when it is in use.

Therefore, in summation of the above description, the present invention meets the requirements of patentability, which is hereby submitted for patent application. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An earphone device for motorcycle rider and passenger, comprising:
two safety helmets, each having a built-in or an externally installed loudspeaker aligned toward the ear and a microphone adjacent to the mouth of the motorcycle rider and passenger, and the signal lines are connected to an activity connector, and said activity connector can be disposed at an appropriate position in the safety helmet in a built-in or externally installed fashion;
two main circuit boards (main system), further comprising an electric power switch, a volume button, a interactive conversation switch, a mobile phone connector, a interactive conversation designed connector, and a conversation connector; wherein the two mobile connectors are connected separately to the earphone connector of the handset by a connecting wire; the two conversation designated connectors are connected with each other by a connecting wire; said two conversation connectors are connected to the activity connector of the safety helmet by a connecting wire such that the loudspeaker and the microphone in the safety helmet can be connected directly to the handset of the mobile phone, and the loudspeaker and microphone of the two safety helmets can be mutually operated, and also be connected or interrupted by the control of the conversation mode switch; by means of the foregoing arrangement, it accomplishes the structure of a mobile phone earphone for motorcycle rider and passenger.
